(19) United States
(12) Patent Application Publication
(10) Pub. No.: US 2009/0031213 A1
(43) Pub. Date: Jan. 29, 2009

(54) SYSTEM AND METHOD FOR WEBSITE COLORIZATION

(75) Inventors: Mark GOLDENBERG, Montreal (CA); Robert HIRSCHEIMER, Hampstead (CA); Fadi EL-ETER, Montreal (CA); Patrick KELLY, Montreal (CA)

Correspondence Address: MERCHANT & GOULD PC, P.O. BOX 2903, MINNEAPOLIS, MN, 55402-0903, US

(73) Assignee: MYEVENT.COM INC., Old Montreal (CA)

(21) Appl. No.: 12/130,298

(22) Filed: May 30, 2008

Related U.S. Application Data
(60) Provisional application No. 60/924,843, filed on Jun. 1, 2007.

(51) Int. Cl. G06F 17/00

(52) U.S. Cl. 715/235

(57) ABSTRACT

A method permits a user to modify color attributes of a website. The website is based on a template being made of CSS documents, and a folder containing images for the website. A subfolder containing the images in a grayscale version and an additional folder for the layered images that are required for the template preview mechanism in the Graphic User Interface are also provided. The template is separated into at least two areas, each area being composed of a plurality of layers. Images within each area of the template are grouped and each group is attributed an initial color and each group being provided with a coloring method. The method involves the steps of selecting by the user a template for a website; displaying the template to the user with initial colors; identifying each area of the template; providing a graphical user interface by which the user selects a given area of the template and modifies a color thereof; and modifying the color of an area of the template according to the user's selection and according to the colorizing method.

### FIELD OF THE INVENTION

The present invention relates to a system and method for website colorization.

### SUMMARY OF THE INVENTION

The present invention applies the concept of dynamic image generation to a website design template system. It makes technological advancements which push and extend the limitations of the existing technology to a new level. The advancements in the system provide non technical users a level of ease and flexibility for controlling the colors of sophisticated design templates that was not possible before. The key advancements achieved by the system replace the need for a graphic designer to intervene manually in order to manipulate the images within a template. The automation of this manual step that requires a skilled graphic artist is critical. The system essentially reduces the challenge of colorizing a website to a simple “paint by numbers” interface. This reduces costs, increases speed, and substantially lowers the skill set required by the user to make color changes within a template.

### SUMMARY OF THE INVENTION

It is an object of the present invention to provide a system and method for permitting users to more easily change a coloring scheme of a template used to build a website.

In accordance with one aspect of the invention, there is provided a method for permitting a user to modify color attributes of a website, said website being based on a template, the template being made of CSS documents, and a folder containing images for said website, a subfolder containing said images in a grayscale version and an additional folder for the layered images that are required for the template preview mechanism in the Graphic User Interface; said template being separated into at least two areas, each area being composed of a plurality of layers, grouping images within each area of said template, each group being attributed an initial color and each group being provided with a coloring method;
said method comprising the steps of:
(a) selecting by the user a template for a website;
(b) displaying said template to said user with initial colors;
(c) identifying each area of said template;
(d) providing a graphical user interface by which said user selects a given area of said template and modifies a color thereof; and
(e) modifying the color of an area of the template according to said user's selection and according to the colorizing method.

Another aspect of the invention provides A system for permitting a user to modify color attributes of a website, said website being based on a template, the template being made of a CSS document, said CSS document including a folder containing images for said website, a subfolder containing said images in a grayscale version and a folder containing layered graphics used to provide real time preview mechanism in the Graphic User Interface; said template being separated into at least two areas, each area being composed of a plurality of layers, grouping images within each area of said template, each group being attributed an initial color and each group being provided with a coloring method; said system comprising:
(a) an interface for permitting a user to select a template of said website;
(b) a display for displaying said template with initial colors;
(c) an interface for permitting a user to select an area of said template and for modifying a color of said area, so that said modified template is subsequently displayed on said display

### BRIEF DESCRIPTION OF THE DRAWINGS

The present invention will be better understood by reading a description of a preferred embodiment thereof made in reference to the following drawings, in which:

FIG. 1 illustrates grouping of images;

FIG. 2 is a schematic diagram of the system of a preferred embodiment of the invention;

FIG. 3 illustrates the notion of dithering;

FIG. 4 illustrates the notion of filtering;

FIG. 5 shows an image of a single uniform color;

FIG. 6 shows an image with three colors;

FIG. 7 is an image which initially appears to be composed of two colors;

FIG. 8 is a portion of the image of FIG. 7 which shows that the image is formed of a plurality of colors;

FIG. 9 is a representation of an image which contains shades of a base color;

FIG. 10 is a representation of a typical photograph which can contain millions of colors;

FIG. 11 is a representation of the image of FIG. 10 subjected to a filtering process;

FIG. 12A is a sample of a template for a web page according to a preferred embodiment of the invention;

FIG. 12B is a grayscale version of the template of FIG. 12A

FIG. 13 shows the structure of the template divided into areas;

FIG. 14 shows the banner area with all the layers;

FIG. 15 shows each layer of the banner area;

FIG. 16 is a typical GIF mage which is used for repetitions, for example in a menu;

FIG. 17 shows the content area for the web page template;

FIG. 18 shows the layers of the footer area;

FIG. 19 shows the footer with all the layers;

FIG. 20 is a screenshot of a page of the profile selection interface;

FIG. 21 is a screenshot of the profile form;

FIG. 22 is a screenshot of the template before the coloring process according to a preferred embodiment of the invention;

FIG. 23 is a screenshot of the template of FIG. 22 after the coloring process;

FIG. 24 shows the different levels of the template of FIG. 22;

FIG. 25 shows typical templates;

FIG. 26 is a representation of a button to enter into the coloring process;

FIG. 27 shows an exemplary interface for changing colors;

FIG. 28 shows an exemplary interface for permitting a user to change text in the template, in this case the title;

FIG. 29 shows an exemplary interface for changing a menu in a template;

FIG. 30 shows an exemplary interface for changing a title in a template; and

FIG. 31 shows an exemplary interface for changing text in a template.

### DESCRIPTION OF A PREFERRED EMBODIMENT OF THE INVENTION

The present invention is an online tool which allows non technical users to manipulate the various colors of a website template in real time. This functionality is presented to the user and is best understood as a “paint by numbers” type of interface. The present invention can actually allow the user to change a color property of a website with a single click.

Template management systems are often combined with Content Management Systems (CMS) allowing non technical users to update content online (on web pages, message boards, etc. . . . ), as well as control the look and feel in which the content is displayed.

The Content Management System handles the user entered content, and the Template Management System handles the design aspect, or the “look and feel” for the presentation of the content. The system of the present invention relates to the Template Management aspects of a system.

In order to provide this new Template Management System functionality, the system must carry out several complex tasks, including: writing to files (Cascading Style Sheets), writing to a database, and creating and colorizing images “on the fly”. Images “on the fly” are images created dynamically by a server side script (explained further below).

A website can be constructed of many elements. In its most basic and simplistic form, a web page is created from HTML markup. Within the HTML markup, images or other multimedia files may be referenced. Often, scripts and applets such as Java, JavaScript, DHTML, and others are embedded or referenced within the HTML code. Many web pages include another type of code that can be embedded or referenced within the HTML markup, known as Cascading Style Sheets or CSS. Additionally, it is common practice with professional website designs to incorporate a graphic or image or multiple images within the design. Therefore, a true system for colorizing websites must take into account at least all these elements.

A major limitation of existing technology is that professional web designs incorporate graphics that can't be fully modified (specifically colorized) “on the fly”. This is due to the inherent problems and issues involved in colorizing images “on the fly”. Therefore, the colorizing of images for various color versions of a single template design must be handled manually by a graphic artist in an image editing program such as Adobe Photoshop. Once various versions of the graphics have been produced, the template system will swap out the appropriate color of graphic based on the color choice of the user. This means that only pre-defined colors (which have been manually manipulated by a skilled graphic artist) can be offered to the user. This reduces flexibility and requires skill, which is labor intensive, expensive, and not always commercially viable.

Many systems exist that can manipulate CSS to provide alternate backgrounds, and other properties, allowing the system to apply a variety of “styles” to a webpage. CSS can even be used to define the layout of a design. No systems exist however, that are capable of actually manipulating “images on the fly” in a comprehensive template design system. This manipulating of images is different than simply applying and positioning images, which is how current systems work. Some systems may achieve what appears to be a somewhat similar effect using a plug-in like Adobe's Flash. A plug-in is an element of a web page and does not comprise a standalone webpage in itself. Websites can be constructed in Flash. Plug-ins are limited and require the user have the plug-in installed on their PC. The system described herein addresses the challenges of incorporating Flash within a web page; however it also addresses the greater challenges of managing an entire webpage template rather than simply the plug-in.

“Images on the fly” refers to images which are dynamically generated by a server side program or script. These systems are generally limited to generating single images for a specific purpose. A typical example of the use of dynamic graphic manipulation would be the CAPTCHA™ verification system. A random text is generated on an image that only a person can read, effectively neutralizing nefarious automated spam bots. Another typical example demonstrating the use of dynamic image manipulation is in adding a watermark to images that are copyright protected. The use of dynamic image generation in commercial applications has been almost exclusively limited to adding some form of text on an image, and the creation of charts and graphs.

The present invention applies the concept of dynamic image generation to a website design template system. It makes technological advancements which push and extend the limitations of the existing technology to a new level. The advancements in the system provide non technical users a level of ease and flexibility for controlling the colors of sophisticated design templates that was not possible before. The key advancements achieved by the system replace the need for a graphic designer to intervene manually in order to manipulate the images within a template. The automation of this manual step that requires a skilled graphic artist is critical. The system essentially reduces the challenge of colorizing a website to a simple “paint by numbers” interface. This reduces costs, increases speed, and substantially lowers the skill set required by the user to make color changes within a template.

Because there are so many ways of manipulating the contents of web pages, creating a true “paint by numbers website system” presents a specific challenge. Images can be hard coded, included in a script, referenced using CSS, or displayed in programs like Adobe's Flash. Therefore manipulating and coloring images “on the fly” is the greatest challenge for the system. The system must be able to determine what method is required to manipulate each and every aspect of a website's colors including CSS and graphics.

The technology required to accomplish this feat is multi faceted, and can be broken down into specific areas: architecture and system design, graphic user interface, properties (profiling) of templates in a system, and image manipulation. The key innovations have been made in the area of image manipulation.

The architecture of the system includes a mechanism to describe to the system what graphics exist and how to change them (or to change a CSS property).

An example of the obvious type of challenge that arises when manipulating multiple images in a template design is as follows. It is very possible that what appears to be a single image displayed within a template is actually 2 or 3 images that are actually positioned together to appear as one seamless image by either HTML tables, or CSS positioning. The use of multiple graphics necessitates the need to group certain graphics together and not others.

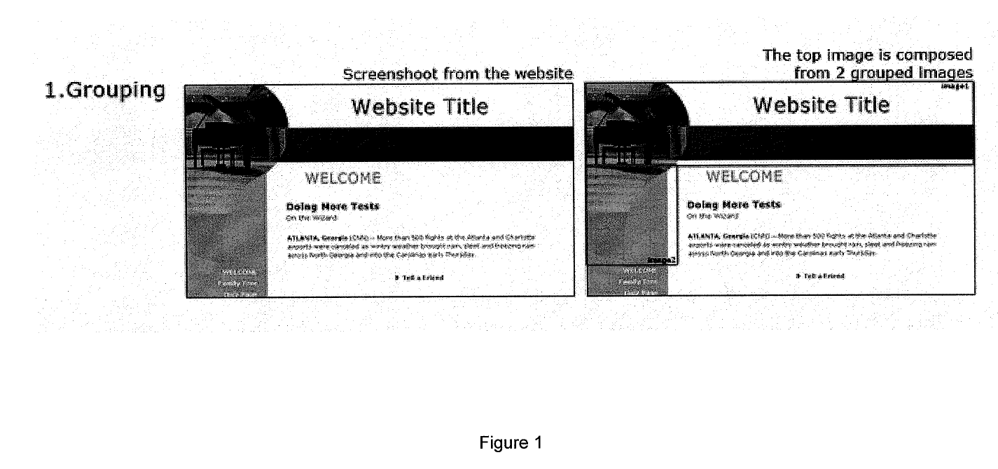

The concept of grouping images is demonstrated in FIG. 1.

In some cases, separate sets of graphics are required as base images in the colorization process. The system according to a preferred embodiment thereof selects the appropriate base images based on the specific function(s) required. For example, if the system calls for a filtering function, a grayscale version of the graphic will be used as the base image from which the final graphic will be created. This allows for a more accurate final color. This effect is explained herein below in more detail.

Defining the template's properties for the design template engine is an important aspect of the system of the present invention. Colors, X/Y co-ordinates, and instructions for the various colorizing functions are required. Moreover, the “profile” or template definition must specify the parts of specific images which are to be colored in conjunction with, and in relation to other images; all have to be clearly mapped out to provide a true color by numbers system. The system of the present invention thus advantageously makes use of a unique architectural framework which can support dynamic colorization within a website design template management system.

This means introducing a method for identifying images, grouping images together, and for assigning colors and properties to images. The system of the present invention uses these properties to determine which coloring method to apply to a given graphic in order to achieve the overall result within the context of a specific template. To do this, the system of the present invention uses a template definition mechanism which is comprised of CSS, user settings, and the definition of the templates themselves and all their parts (images, html, etc. . . . ). The system uses a database structure combined with stored files, as well as dynamically generated files.

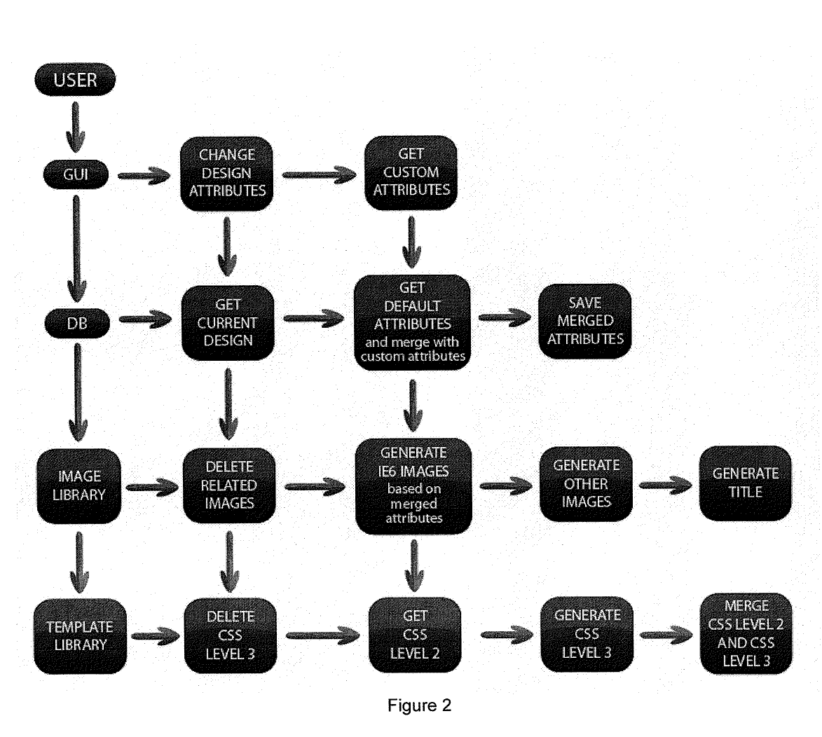

The flow chart of FIG. 2 illustrates the basics of the Template Management System. The system specifically uses a database and files, although the entire system may be run with only files. Fig. begins with the user interacting with the application through a form or GUI (Graphic User Interface). The user's preferences regarding their choice of website template design and choice of colors are stored in a database.

The website templates are structured with three layers of Cascading Style Sheets (CSS). The first level or layer is the most generic level of CSS, and is applied to all the template designs defined in the system. The second layer of CSS is unique and specific to each template. It defines the default image colors, and the base images that will be required later by the system to create custom colored versions of the template. The third and final layer of CSS is unique and specific to each user using the system. It contains all the custom fonts, colors, graphics, etc. The CSS files are a combination of existing files, and dynamically generated files based on user settings stored in the database.

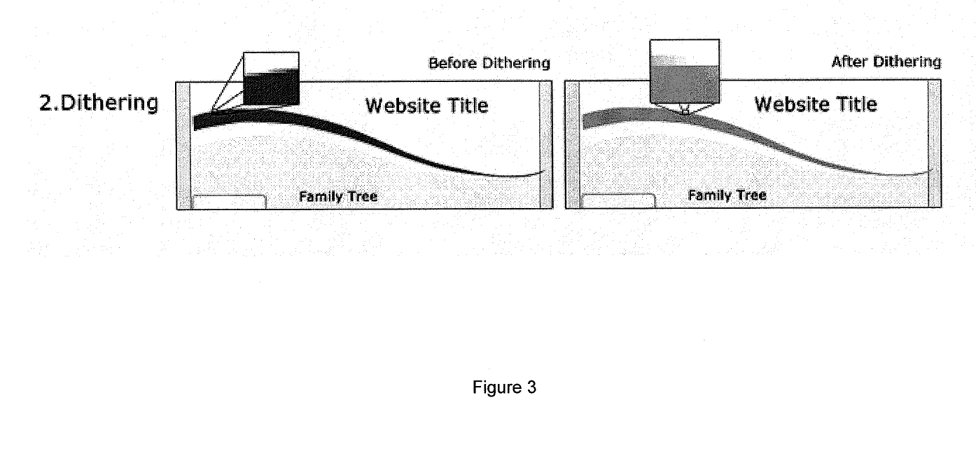

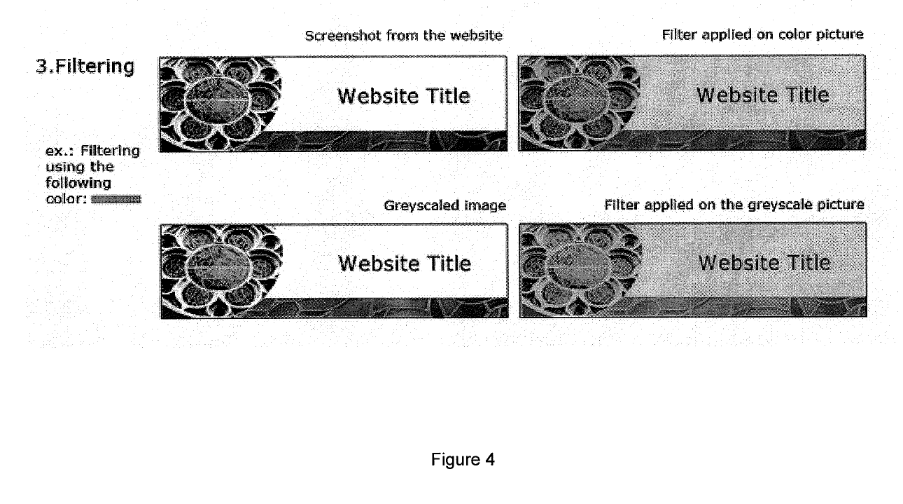

In addition to the HTML, CSS, JavaScript, Plug-ins, Flash, and all other elements that make up the template designs, the system requires information about the template in order to re-color the template effectively. Therefore a “profile” is created for each template. The profile defines what images must be colorized using which technique. For example, it may indicate that three associated graphics in the design must be colored the same color and the same method (grouping). It may require a filter be applied, or it may be a dither, or even a simple re-coloring process. Dithering and filtering are illustrated in the FIGS. 3 and 4 respectively, and will be explained later. Having analyzed the template's profile, the graphic colorizing system finally creates new graphic files.

The new graphics that were created by the system are dynamically referenced, and written into the 3^{rd} layer of CSS to effectively produce a custom colored version of the user's chosen website template design. The final graphic outputs are the graphic files which are in either the .png, .jpg, or the .gif formats. Transparent .gif and .png files are also used and are a factor when managing the color of a template.

The innovation described above relates specifically to the framework required to manage the automation of image manipulation functions within the overall context of a template management system. In order to achieve this overall result, specific dynamic image manipulation techniques are required. Some of these techniques include concepts such as “dithering”, “filtering”, and other methods used in dynamically changing the color of a graphic. These techniques are integrated within the larger template system.

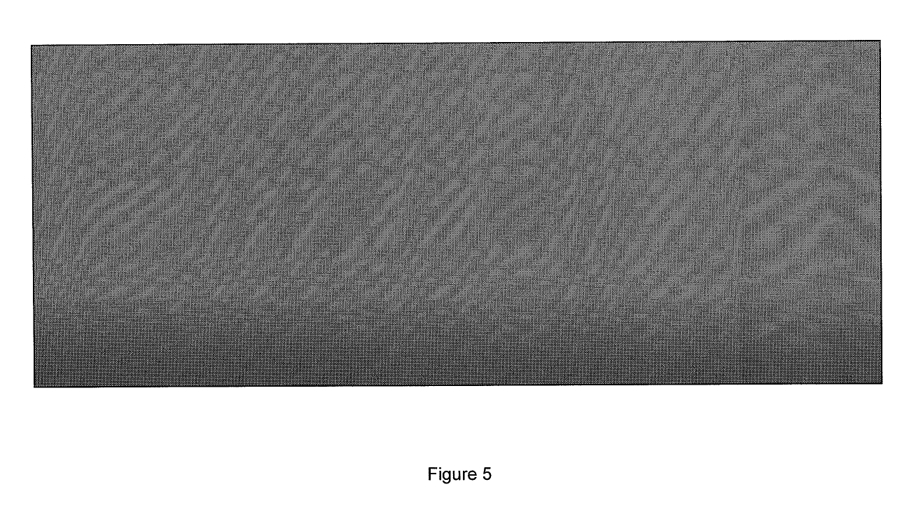

Consider the challenge of coloring an image. Images can be very simplistic, or infinitely complex. If an image like a 1×1 pixel background graphic is a single uniform color, (for example green), in theory, one could use the existing technology of PHP and the GD library to change the image color to a different color such as red. This is primarily possible because GD provides PHP with an index for each color of a graphic. In this case, since there is only one uniform color, it's fairly simple to tell PHP and GD to recolor that specific color index within the image, see FIG. 5.

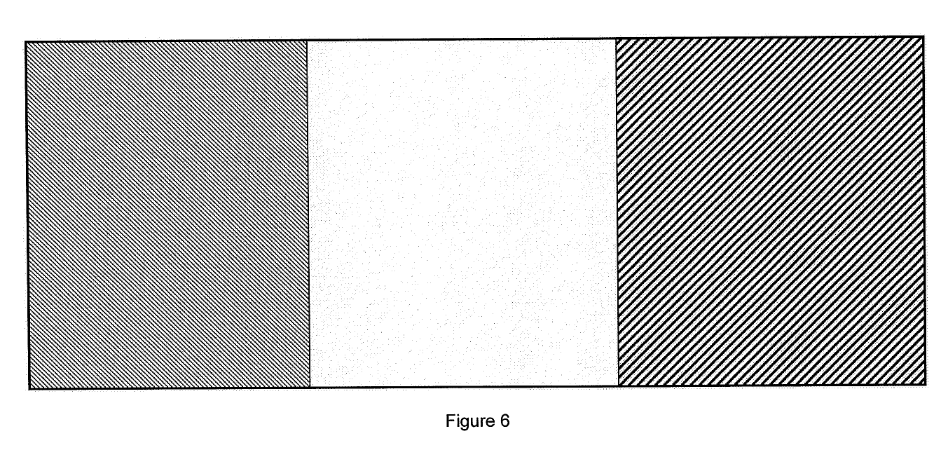

A slightly more complex example can be seen below in FIG. 6. In this scenario the image has three colors (red, white and blue). This makes it more difficult to colorize because only one index in the image can be colorized at the same time. Therefore, the application must determine which colors are represented by which index at specific locations within the image in order to colorize the image in an orderly fashion. By supplying the appropriate function with the location of a specific color within the image (expressed via X/Y coordinates), the correct color can be extracted and used in the next step to re-color that specific index (color) within the image.

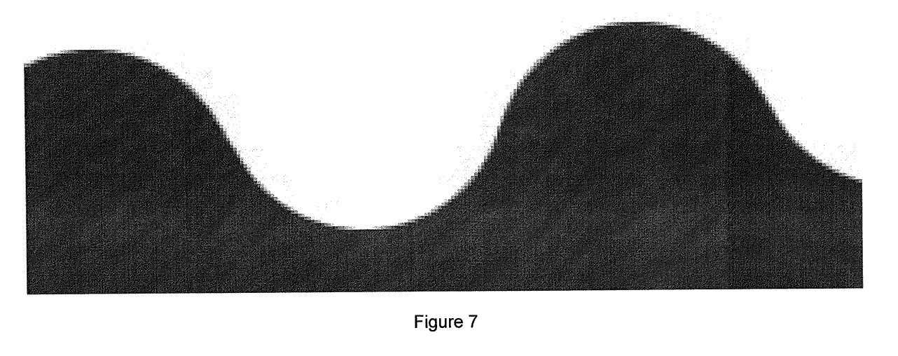

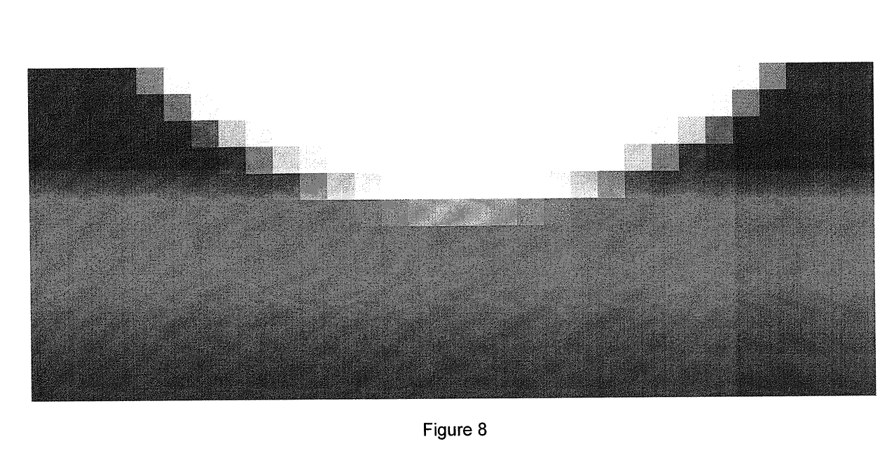

In the following case, we have reached the limitation of existing technology to effectively re-colorize the image to commercial quality standards. Consider the image displayed as FIG. 7. To the untrained eye, this image may at first appear to have only two colors (indexes). In fact, there are a multitude of colors present in this image. If the artist who created this original image had truly only used two colors, the curve would appear to be jagged and pixilated. In order to give the illusion that the curve of the graphic is actually smooth, there is a soft gradation of one color into the next. This effect called “dithering” can be fully appreciated by examining FIG. 8. There are no existing technologies capable of automating the dithering process.

The system of the present invention takes an innovative approach to solving this problem. The system first determines the two colors that are bordering each other. Once the colors are known, the application applies an algorithm to successfully blend the colors together to achieve the desired result. Therefore the system effectively allows for automation of the dithering process. This process works well with images that have clearly defined colors and borders, but does not work in every situation.

### Dithering

Some basic terms used in this field can be defined as follow before listing the steps in the dithering process.

First color: One of the two original colors of the original dithered graphic. This is the color that the system will replace with the user's selected color.

Second color: The other color of the original dithered graphic. The dithering process occurs between the First and Second Color. (The second color will not be changed as will the first color).

New color: The new color is the color that replaces the first color. In order to replace the first color and preserve the dithering in the graphic, the system will have to create a dither to replace all the colors in between the first and second colors with those colors that are in between the new color and the second color.

Color: For the purposes of this document, color refers to the RGB value of a color. The RGB value, or the Red, Green and Blue value of a color is expressed as three, three digit numbers separated by a comma representing the Red, Green, and Blue values of a color. For example, light gray expressed as “999999” has the following RGB values: 153=R, 153=G, and 153=B. Therefore, when comparing colors mathematically, we are actually comparing three numbers (RGB) for each color.

Consider the following example using the following colors:

First color=200, 100, 50
Second color=0, 0, 0
New color=200, 200, 200

In order to achieve a successful automated dithering process, the following steps are followed. It should be apparent to a person skilled in the art that this is a preferred manner in automating the dithering process, but that other methods will meet the objects of the present invention.

1) Subtract the Second color from the first color.

### R 200−0=200

### G 100−0=100

### B 50−0=50

2) Divide the difference by 16 (related to color bits)

### R 200/16=12.5

### G 100/16=6.25

### B 50/16=3.13

3) Repeat steps one and two using the new color instead of the second color. Subtract new color form first color.

### R 200−0=200

### G 200−0=200

### B 200−0=200

Divide difference by 16

### R 200/16=12.5

### G 200/16=12.5

### B 200/16=12.5

4) The next part of the process involves determining the colors that are needed to recolor those colors which are the “in between” colors. To accomplish a quality dither, we found through trial and error that a minimum of 16 “in between” colors are required in order to achieve a visually smooth dither. Accordingly, a loop is executed with 16 iterations. In each iteration, the loop creates one of the “in between colors”. It does so by applying the following formula;

### Determine the Dither Between the First and Second Colors:

First color+the difference between the first color and the second color (as calculated in step 1)×$i(where $i is the iteration)=the color, where the color represents the “in between color” which is one step of 16 of the “in between colors” in the dithering process between the first and second colors.

### Determine the Dither Between the New Color and Second Colors:

New color+the difference between the new color and the second color (as calculated in step 3)×$i(where $i is the iteration)=the color, where the color represents the “in between color” which is one step of 16 of the “in between colors” in the dithering process between the New and Second color.

Each iteration of the loop therefore replaces one sixteenth of the in between colors.

The same loop of 16 iterations is actually run 3 times. The first time the loop runs, it applies the “round” function on the result of the formulas listed above. The second time the loop is run, it runs the same loop except it now uses the “floor” function on the result (lower range). The third and final time the same loop is run using the “ceil” function (upper range) on the result. Finally an average of the three results is taken to obtain the final 16 colors of the dither. By using this technique, a more accurate result is obtained by sampling a larger range of colors.

FIG. 3 demonstrates the impact of how the dithering functionality works within the context of an actual website design template.

### Filters

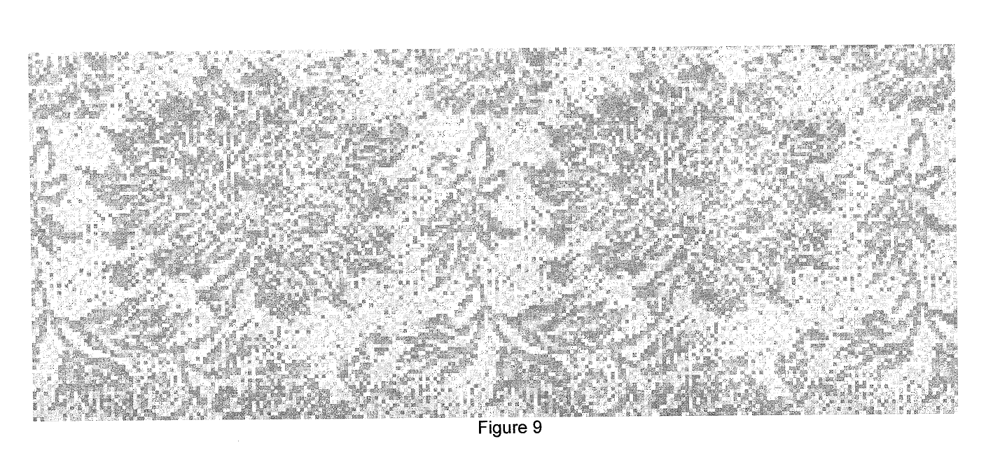

The use of patterns is very common for creating a background for a web page. Often patterns do not have clear borders between two simple colors, and they usually employ many shades and varieties of a basic color. An example of this type of graphic is displayed below in FIG. 9. There are no existing technologies capable of automating the re-coloration of a jpeg graphic such as this.

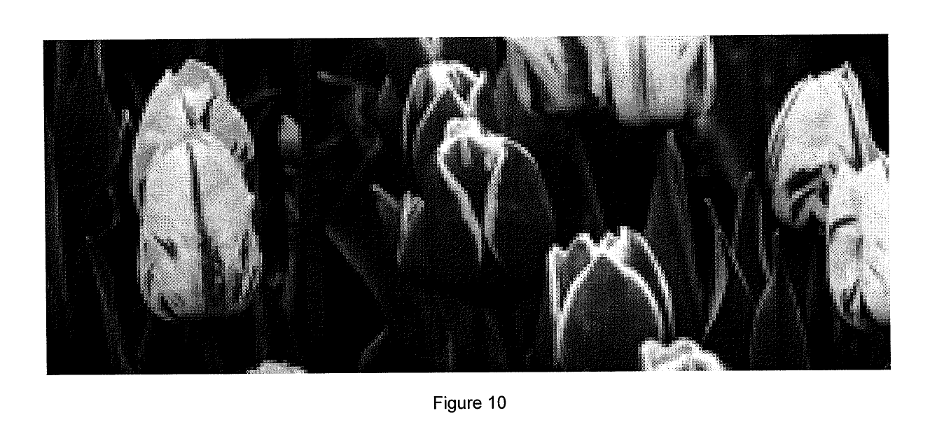

Some images such as photos can contain millions of colors. In the case of photographic images, it would be impossible to re-colorize each color pixel by pixel. Even if it were theoretically possible, it would be much too slow, and would be too much of a drain on the host computer's resources. FIG. 10 illustrates such an image.

The system of the present invention solves the challenges previously mentioned when coloring photographic images and images of the type shown in FIG. 9. This is achieved via the application of a filter. Rather than attempting to re-color the image pixel by pixel, the system applies a single color as a sort of tint on the graphic. This ability essentially allows to apply a specific color to almost any design.

Until now, automated filtering has been beyond the reach of current web based technologies. Attempts have been made at creating filters, however they were only partially successful and not of high enough quality to be used in a commercial setting. Furthermore these existing filters require a specifically coded function for each specific filter color, ruling out those methods for a dynamic automated system where any color may be chosen by the user.

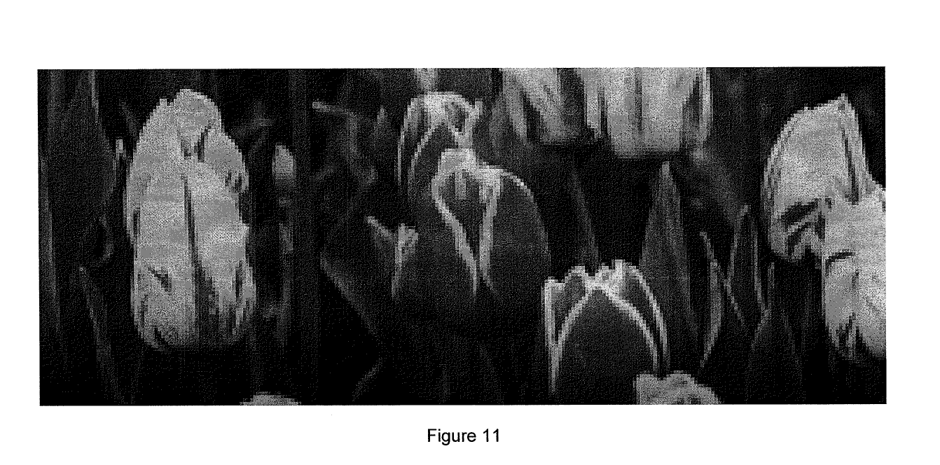

In order for a filter to work properly, it has to re-colorize the image, while respecting the light and dark contrasts within an image. The overall lighting of the image is also important. The present invention overcomes these hurdles through the use of algorithms (described further below) in order to determine the exact color and the opaqueness of the color to create the filter. The final result of applying a filter on the image in FIG. 10 can be seen in FIG. 11.

The filtering process begins by taking the selected color of filter and converts it to RGB mode. Once in RGB mode, the program identifies the various colors in the graphic and loops through the colors. For each color in the graphic (or each iteration of the loop), the following routine is run:

Create a blank color.

Set the red value of the new graphic to the same as the red value of the original graphic.

Determine the red value of the selected color of the filter, and divide by 2.

Add to result to the red value of the new graphic.

This process is repeated for both the Blue and Green values of the RGB graphic.

The process works well, however the final color will not be the exact color that was chosen for the filter. This is because the filter color is mixing with the existing colors of the template's graphics. This problem is overcome by using a version of the original graphic that is a neutral color. Therefore the system requires a set of base images for each template in the system that includes a complete set of grayscale images. When the filtering functionality is activated, the system uses the grayscale set of graphics to add a filter in creating the final output of image files. The final result is a graphic that is much closer in color to the originally selected color.

FIG. 3 clearly demonstrates the effect of using a neutral grayscale base image rather than a colored one.

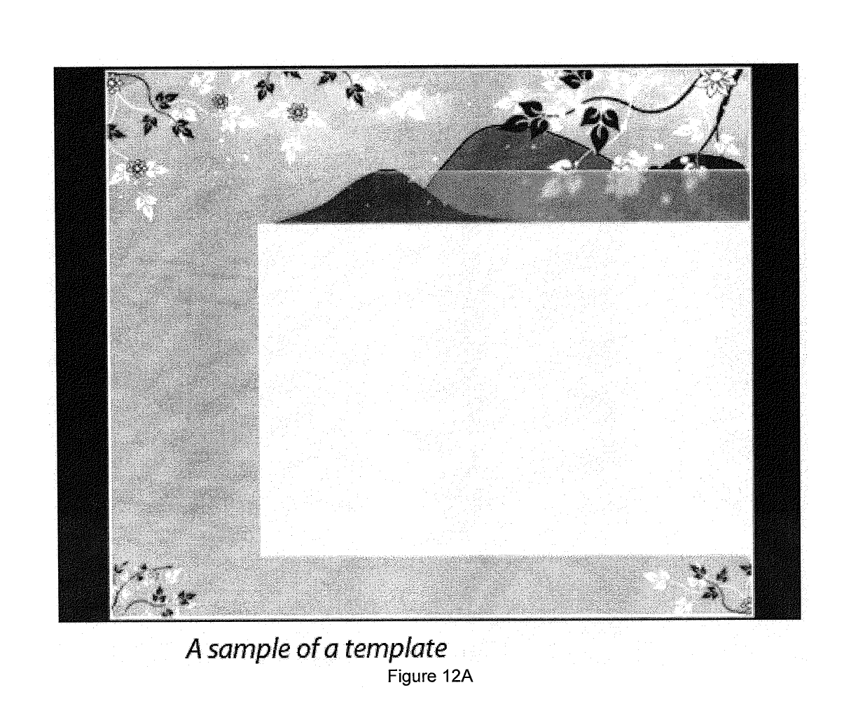

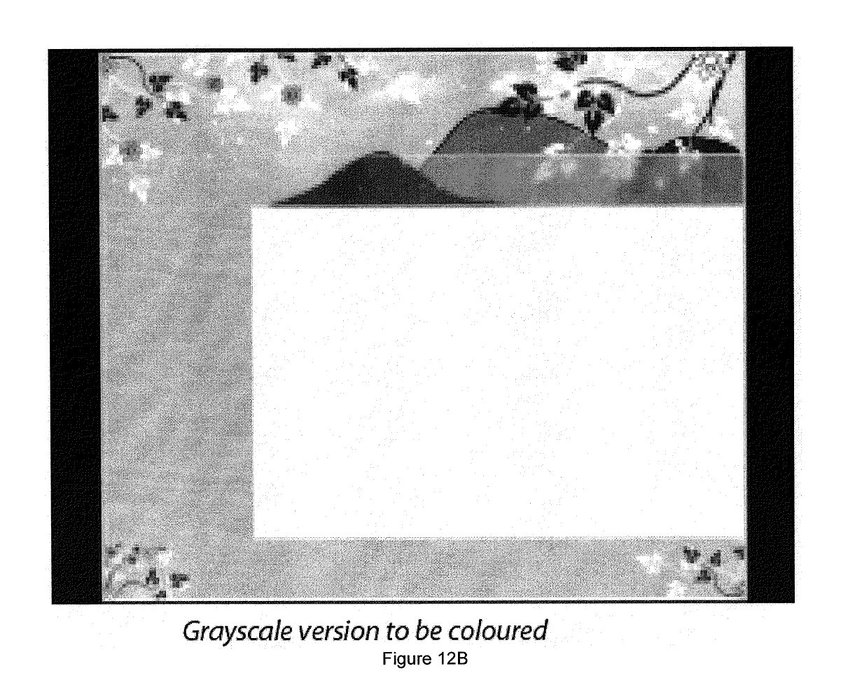

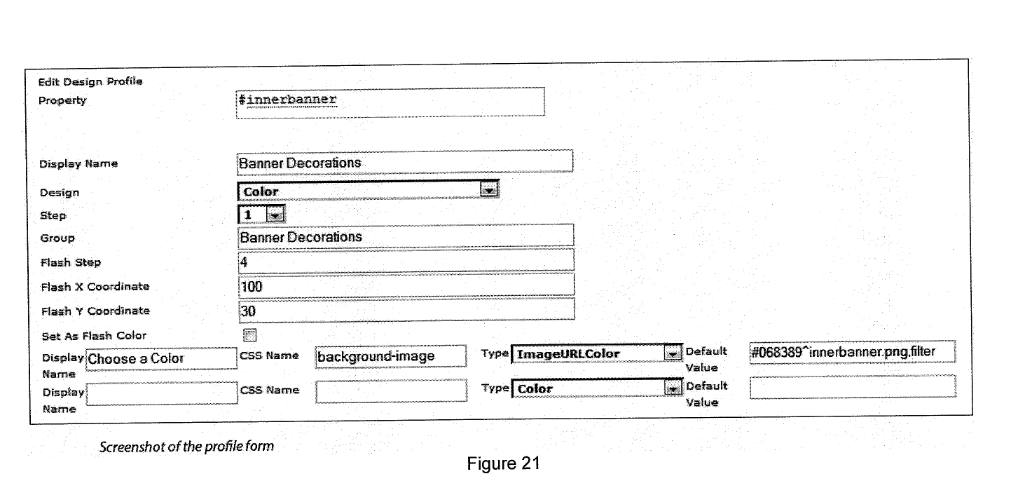

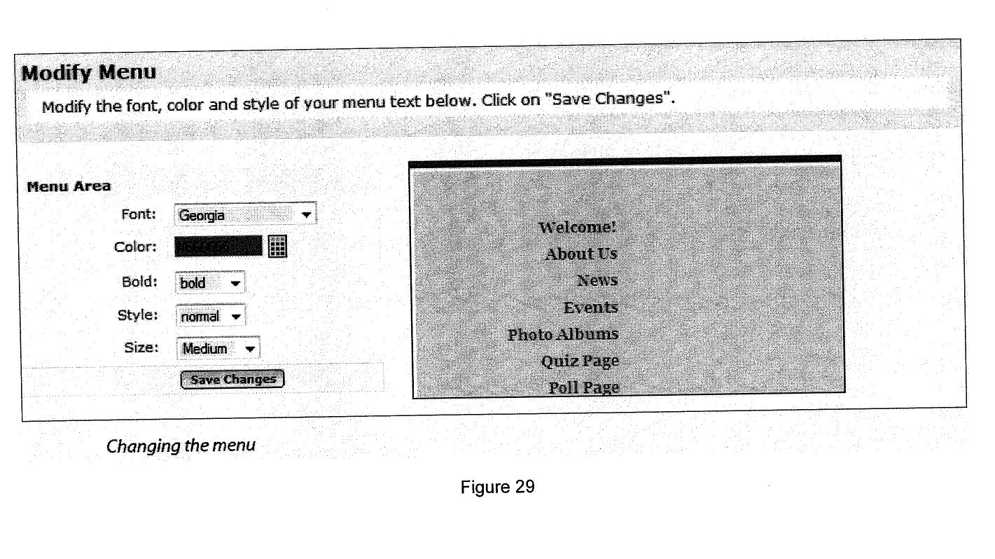

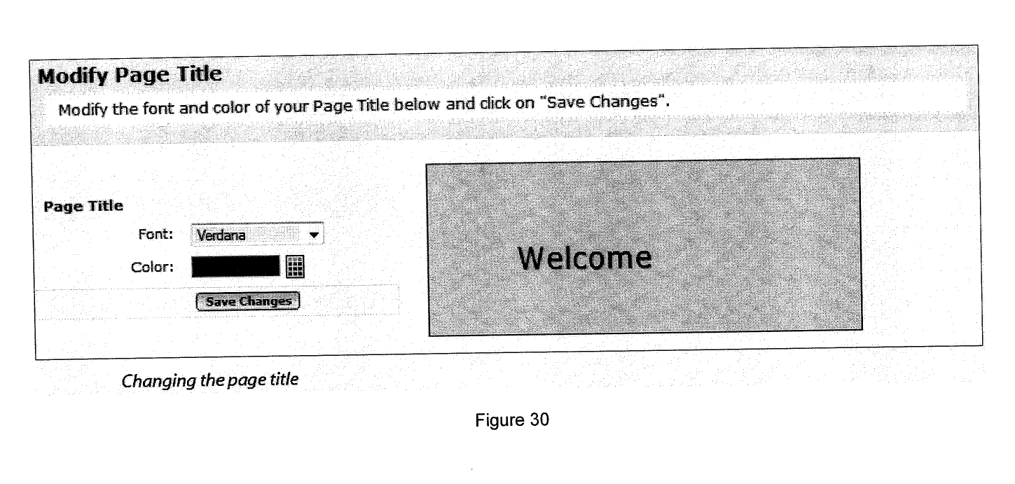

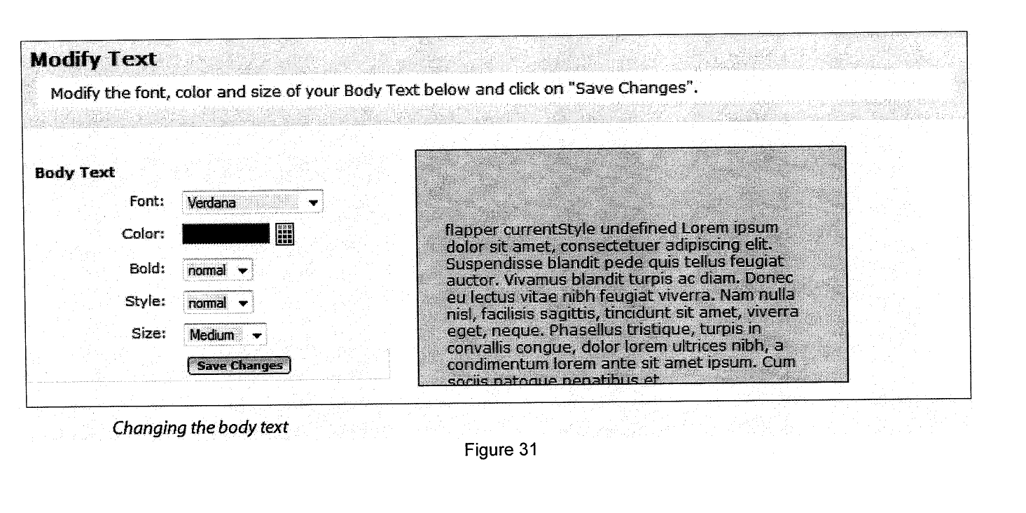

Referring now to FIGS. 12A to 31, an example of the system and method of the present invention will be described.

It will be apparent to a person skilled in the art that the present invention has many aspects. The first aspect is that of the designer's perspective. Indeed, the purpose of the present invention is to allow unsophisticated users tools to design and personalize websites based on predetermined templates. Of course, this limits the actual artistic expression by users, but enables the users to have some control over a website design without having to resort to professional graphic artists.

Thus, the designer creates a number of templates, such as the one illustrated in FIG. 12A. The template is typically made up of a CSS document, a folder containing all the image files (FIG. 12A), a subfolder with the same images in grayscale versions (FIG. 12B), and an additional folder containing all the required images that are used for the layered preview mechanism in the Graphic User Interface.

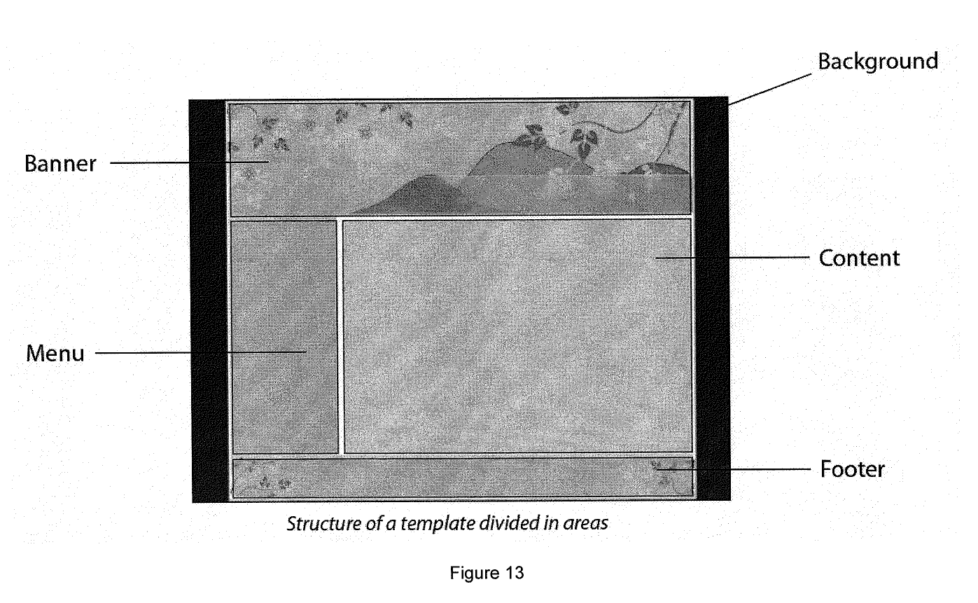

The template can be decomposed into a number of areas, shown for illustration purposes in FIG. 13 as banner, background, content, menu and footer. Other templates can have more of less of these areas.

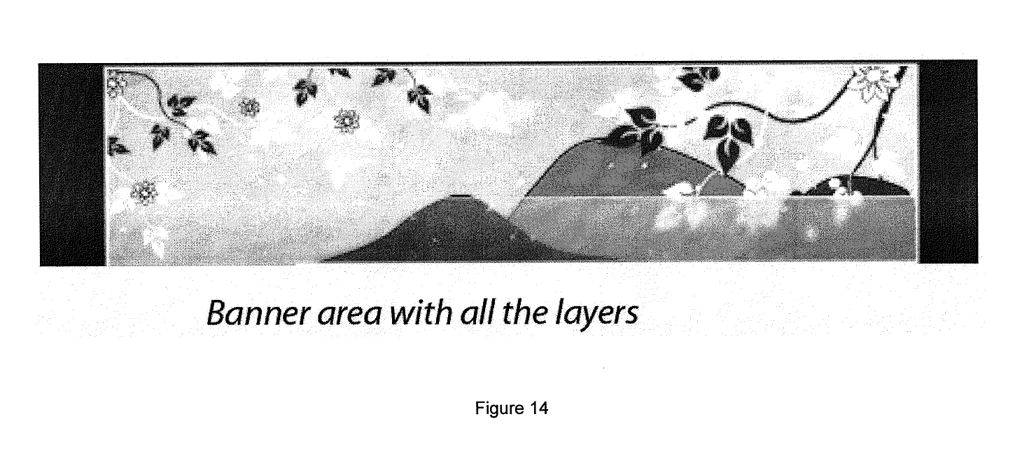

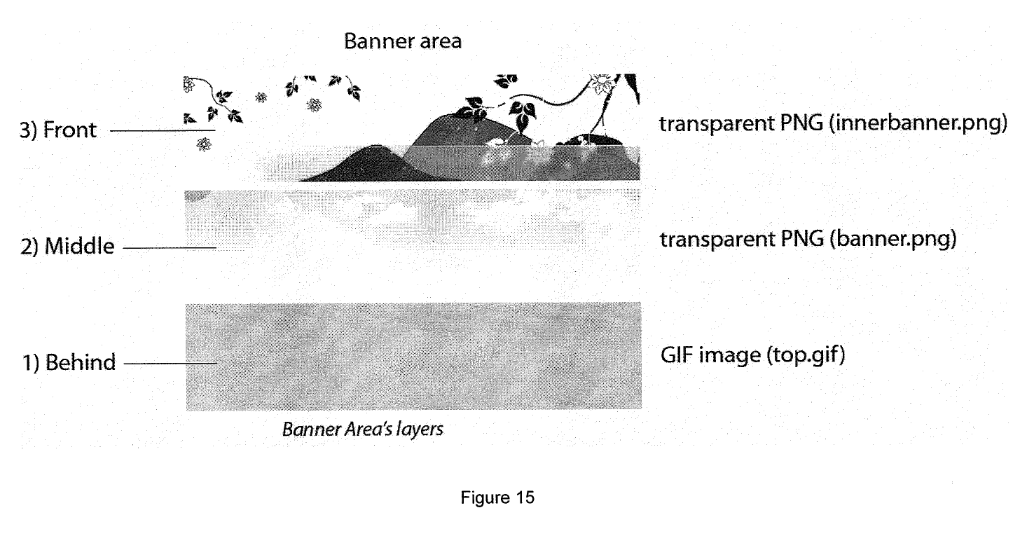

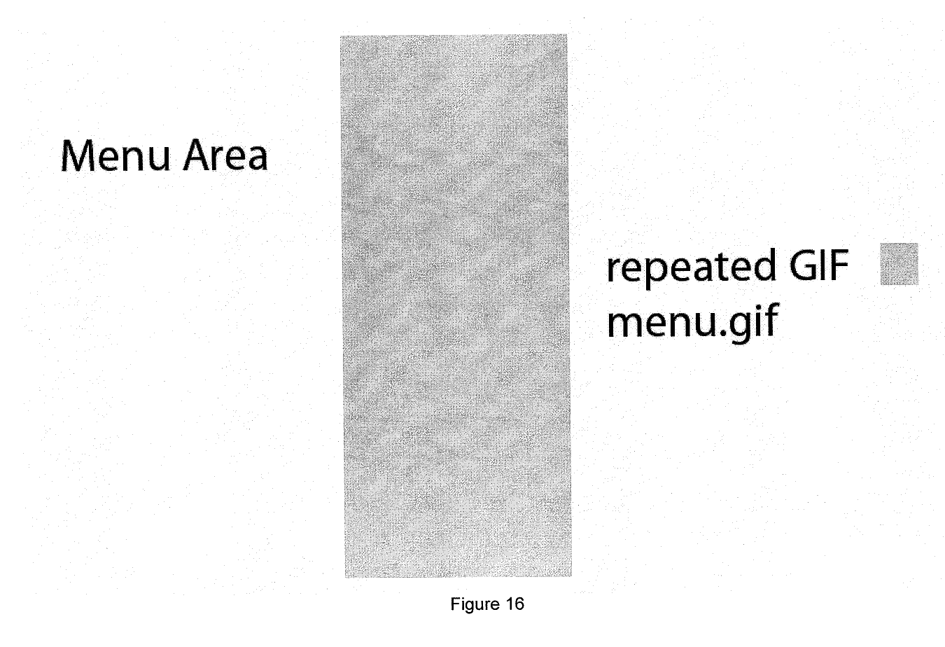

Each area usually has a plurality of layers (see FIG. 14, showing a banner area with all its layers), which are decomposed into behind, middle and front, as show n in FIG. 15. It should be noted here that all the images can be in the GIF, JPG, or PNG format. A person skilled in the art will recognize that GIF images are generally used when there is repetition. For example, a menu area which is usually a one-color area that will be changed into another one-color area is usually in a GIF format (FIG. 16 illustrates this).

The transparent PNG format is generally used for images that will not be repeated, or images that are more complex, such as curves, gradients, textures, etc.

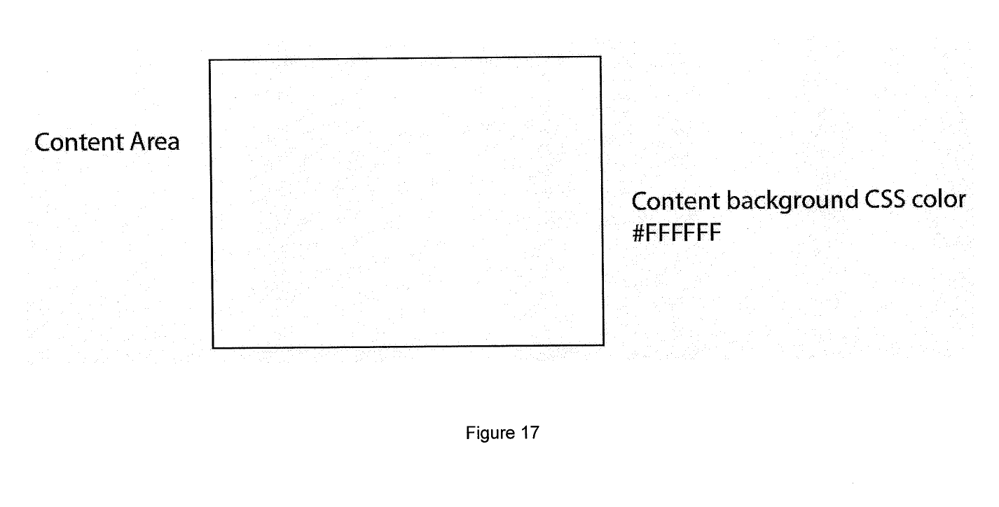

Correspondingly to the above, areas that are not colored by means of a graphic are colored by modifying the appropriate properties within the CSS documents (in this case, the content area of FIG. 17).

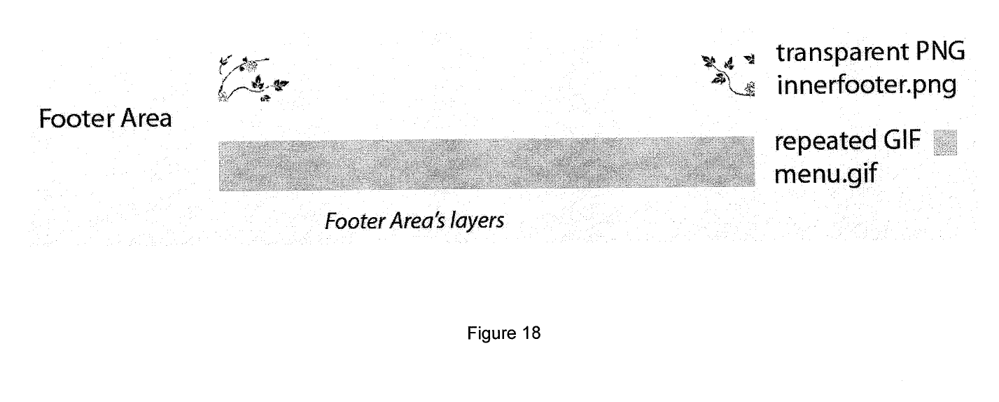

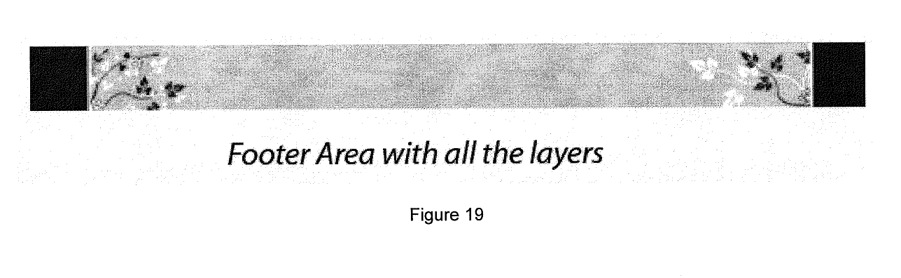

FIGS. 18 and 19 illustrate the footer area.

Once the template has been defined, the images are grouped. Each group has a different color, and is attributed one of two coloring methods: dithering and filtering.

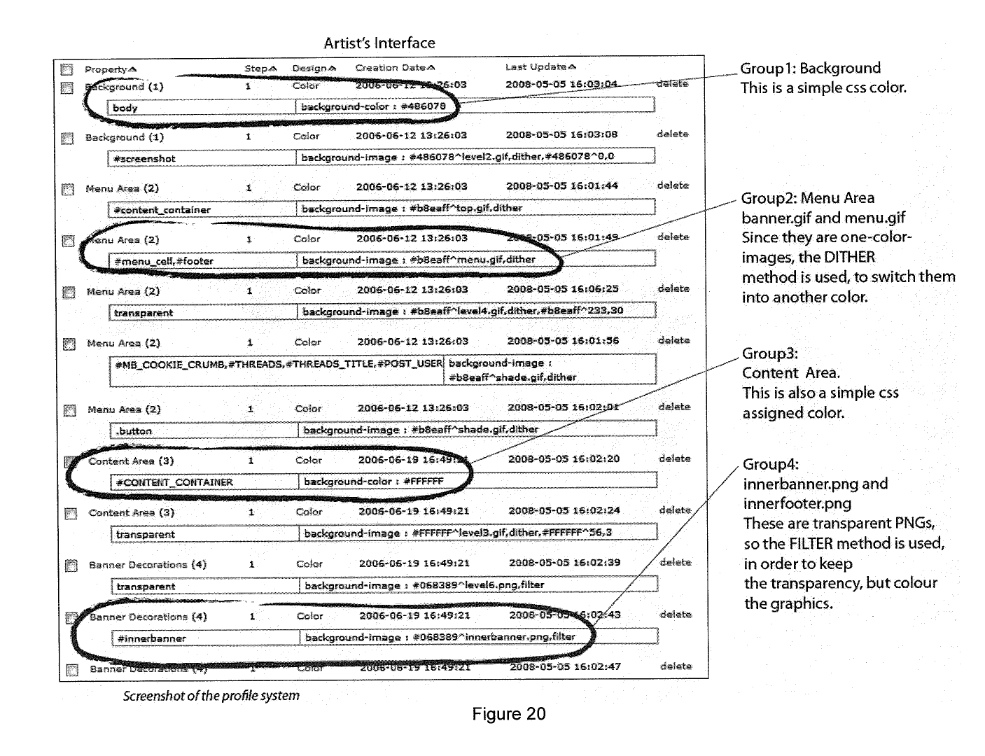

FIG. 20 shows an exemplary interface for a profiling system for a graphic designer. In this Figure, the elements of a given page are grouped, and the relevant information is also determined. As mentioned previously, all elements of a given group have the same color.

Once the templates are appropriately constructed, they can then be disseminated through electronic means, such as a website. A user visiting the website would then have the possibility of selecting a template to build his or her website.

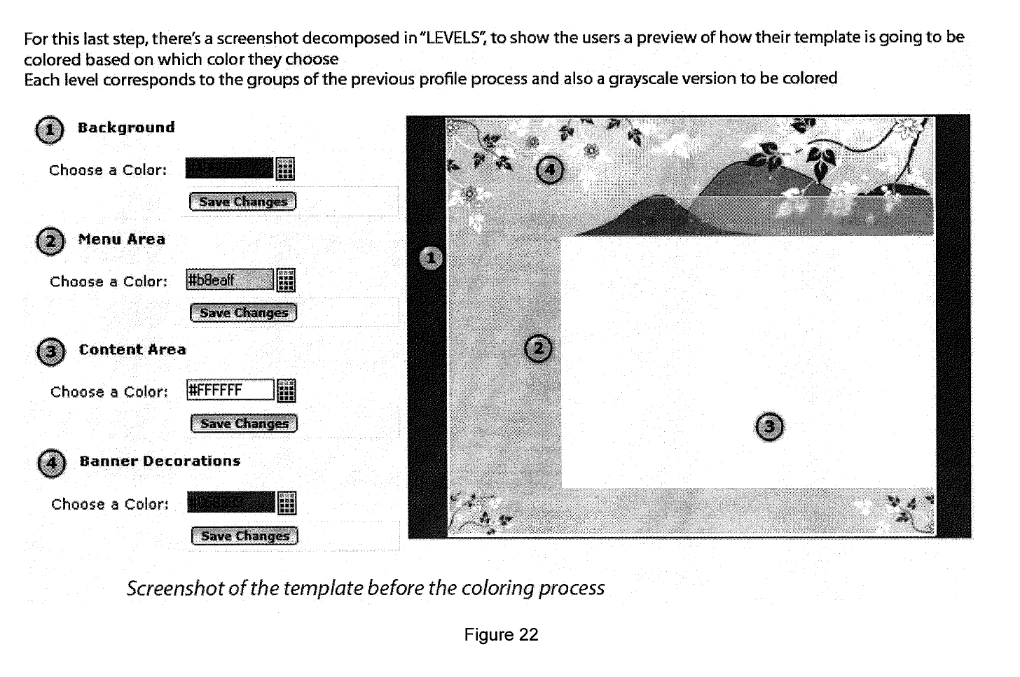

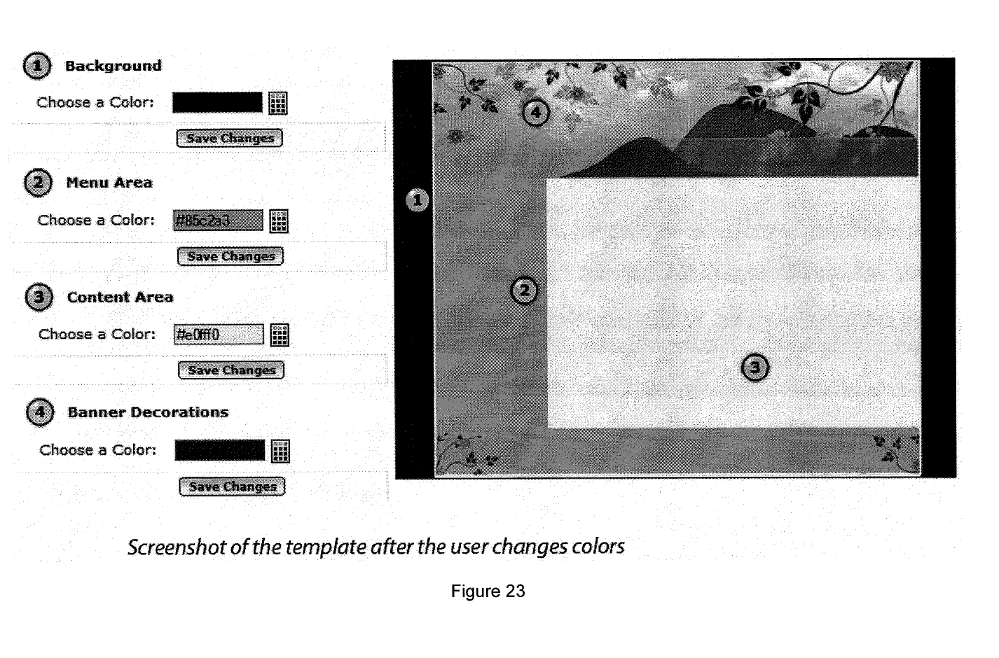

The user, once a template is selected, is then provided with an interface identifying the various areas of the template, and with an interface for selecting a color. FIG. 22 shows a screenshot of a template before the coloring process, whereas FIG. 23 shows a screenshot of the template after the coloring process.

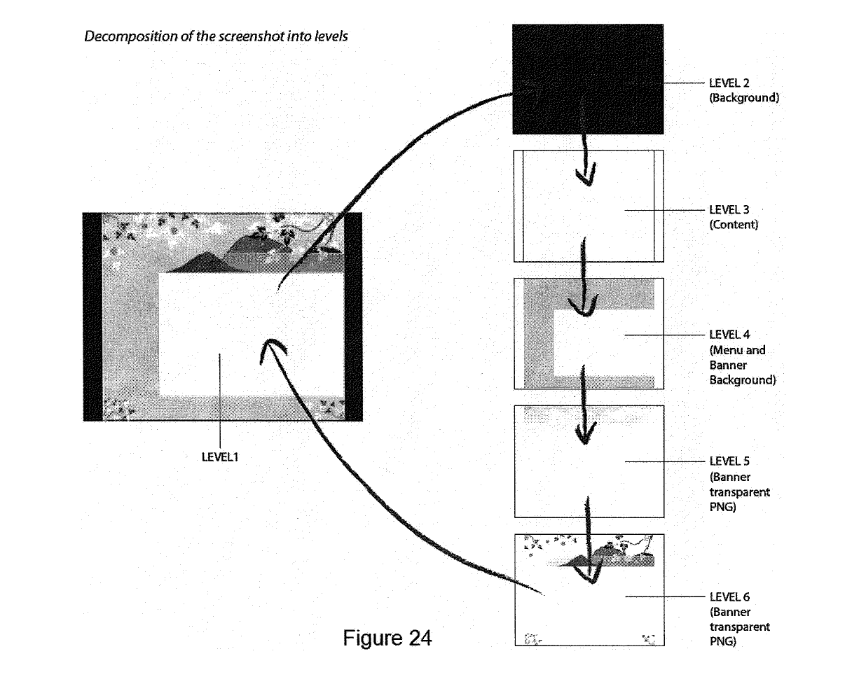

Each area, or level, is shown in FIG. 24, and each can be colored independently of the other levels.

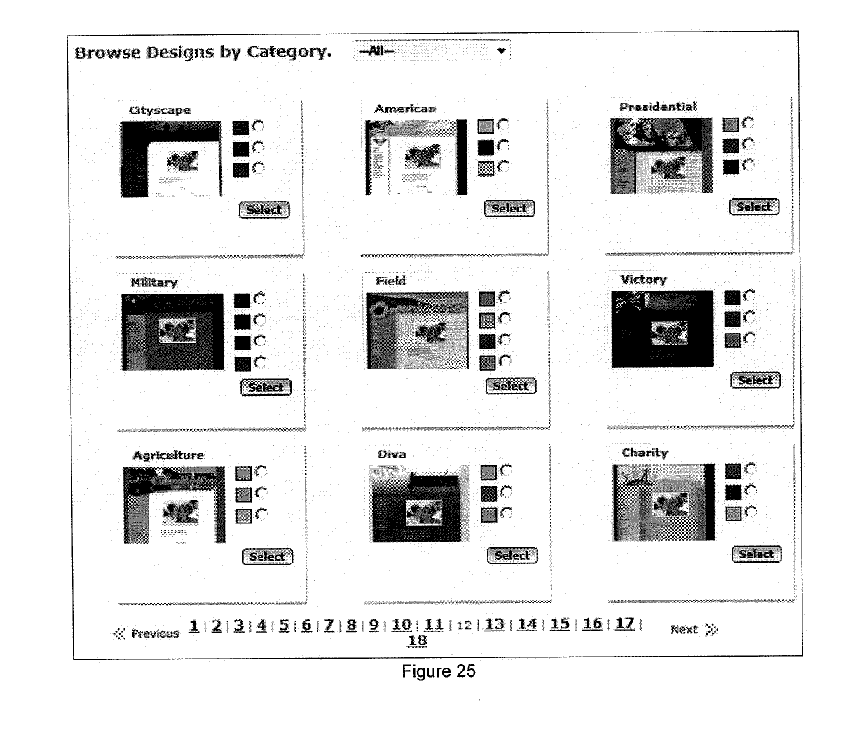

In use, FIG. 25 shows that the user is offered a number of templates from different categories, themes and colors. A person skilled in the art will appreciate that each template may be available in three or four (or more) different versions, and pre-determined fixed colors.

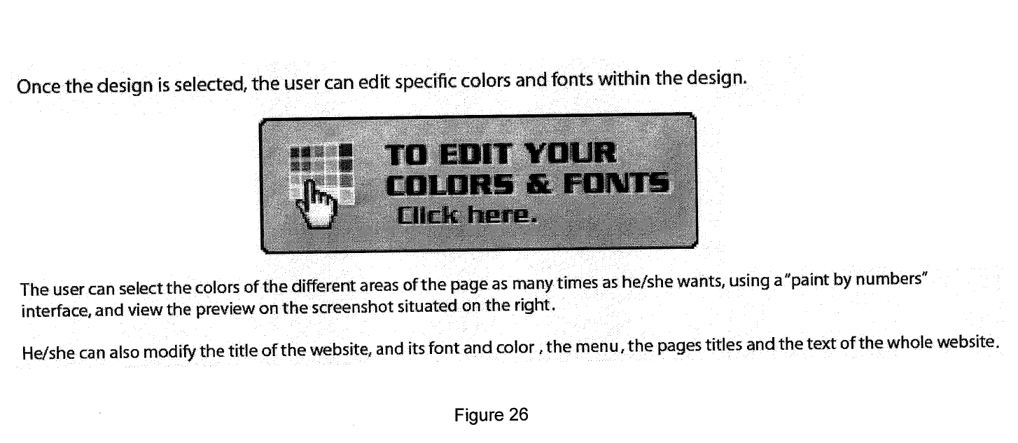

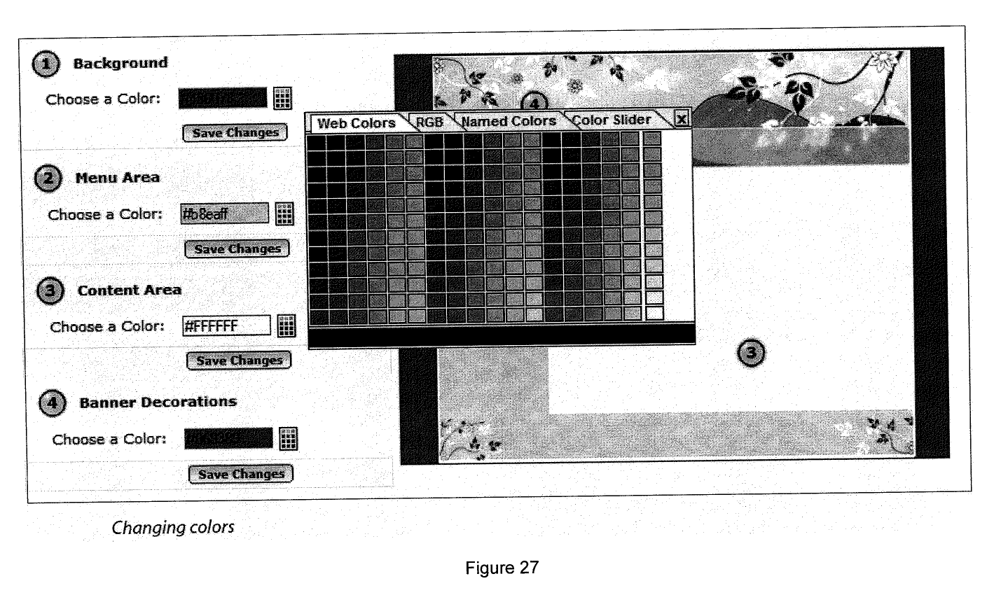

Once the design is selected, the user is prompted to enter into a color modification mode through, for example, a button such as that shown in FIG. 26. An interface, of which FIG. 27 is a typical representation, is then presented to the user for modifying the color scheme of the template.

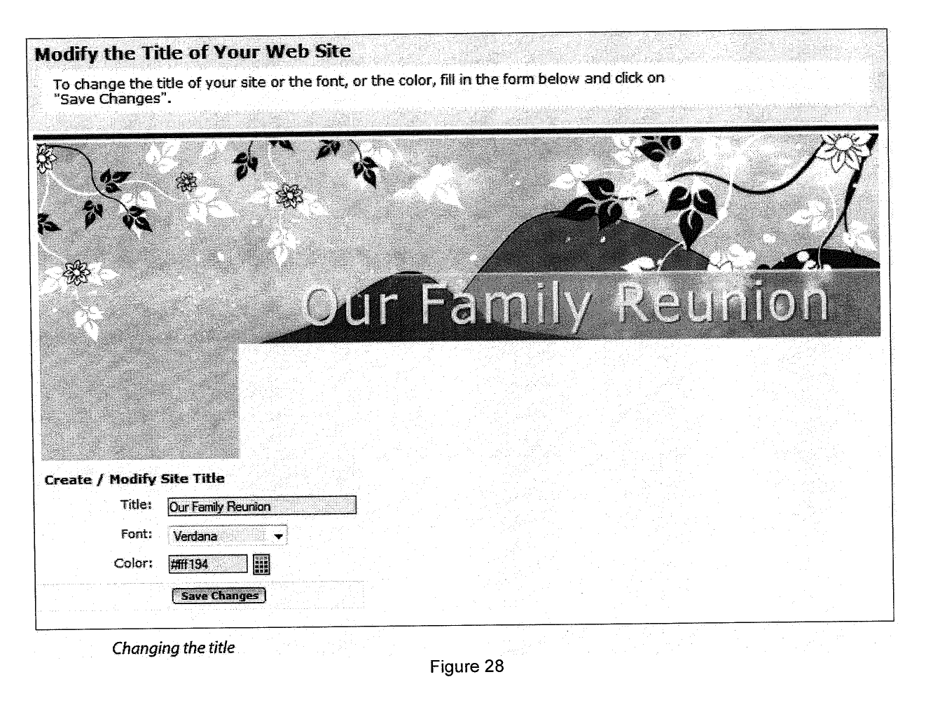

FIGS. 28-31 show exemplary interfaces for modifying various parts of the template.

Although the present invention has been explained hereinabove by way of a preferred embodiment thereof, it should be pointed out that any modifications to this preferred embodiment within the scope of the appended claims is not deemed to alter or change the nature and scope of the present invention.

1. A method for permitting a user to modify color attributes of a website, said website being based on a template, the template being made of CSS documents, and a folder containing images for said website, a subfolder containing said images in a grayscale version and an additional folder for the layered images that are required for the template preview mechanism in the Graphic User Interface; said template being separated into at least two areas, each area being composed of a plurality of layers, grouping images within each area of said template, each group being attributed an initial color and each group being provided with a coloring method;
said method comprising the steps of:
(a) selecting by the user a template for a website;
(b) displaying said template to said user with initial colors;
(c) identifying each area of said template;
(d) providing a graphical user interface by which said user selects a given area of said template and modifies a color thereof;
(e) modifying the color of an area of the template according to said user's selection and according to the colorizing method.

2. A method according to claim 1, wherein said step (c) further includes the step of modifying at least one layer of said area.

3. A method according to claim 1, wherein images of areas of the template are grouped into groups, each group being assigned an initial color, and wherein said step (c) further includes the step of modifying the color of at least one group.

4. A method according to claim 3, wherein at least one group of images is made of an image in a GIF or JPG format, and wherein modifying an initial color of said group includes the step of dithering the initial color.

5. A method according to claim 3, wherein at least one group of images is made of a transparent PNG or JPG, and wherein modifying an initial color of said group includes the step of filtering the initial color.

6. A template for a website, said template being based on CSS documents, a folder containing images for said website, a subfolder containing said images in a grayscale version and an additional folder containing the graphics required to generate a scale preview in the Graphic User Interface, said template being separated into at least two areas, each area being composed of a plurality of layers; images of said template being grouped into groups according to their layer, each group being attributed an initial color.

7. A system for permitting a user to modify color attributes of a website, said website being based on a template, the template being made of a CSS document, said CSS document including a folder containing images for said website, a subfolder containing said images in a grayscale version and a folder containing layered graphics used to provide real time preview mechanism in the Graphic User Interface; said template being separated into at least two areas, each area being composed of a plurality of layers, grouping images within each area of said template, each group being attributed an initial color and each group being provided with a coloring method; said system comprising:
(a) an interface for permitting a user to select a template of said website;
(b) a display for displaying said template with initial colors;
(c) an interface for permitting a user to select an area of said template and for modifying a color of said area, so that said modified template is subsequently displayed on said display.

8. A system according to claim 7, wherein modifying the color of said area includes modifying at least one layer thereof.

9. A system according to claim 7, wherein modifying the color of said area includes modifying an initial color of a group.

10. A system according to claim 9, wherein said color is modified by dithering.

11. A system according to claim 9, wherein said color is modified by filtering.
